(19) United States
(12) Patent Application Publication
(10) Pub. No.: US 2008/0151303 A1
(43) Pub. Date: Jun. 26, 2008

(54) Method Implemented in a Management Information System For Automatic Computation of an Imposing Scheme

(75) Inventor: Dieter Reichhart, Eschweiler (DE)

Correspondence Address: HENRY M FEIEREISEN, LLC, 350 FIFTH AVENUE, SUITE 4714, NEW YORK, NY, 10118, US

(73) Assignee: HIFLEX SOFTWARE GESMBH, 1090 Wien (AT)

(21) Appl. No.: 11/911,003

(22) PCT Filed: Apr. 10, 2006
(86) PCT No.: PCT/EP06/03255

§ 371 Date: Oct. 9, 2007

(30) Foreign Application Priority Data
Apr. 11, 2005 (DE) 10 2005 016 749.7

(51) Int. Cl. G06K 15/00; B41F 13/54; G06F 17/21

(52) U.S. Cl. 358/1.18

(57) ABSTRACT

A method is disclosed, implemented in a management information system for automatically computing an imposing scheme, defining for the production of a print product an association of a sequence of pages (7) of the print product with fields of a sheet, into which the sheet is divided, based on a crease sequence by lines and columns, wherein the crease sequence defines the sequence of the pages (7) associated with the fields in the print product.

In order to simplify the determination of a new imposing scheme it is suggested that a possible division of the sheet is initially selected, based on the one hand, on a sheet format of the sheet, and, on the other hand, on net formats of the pages (7) from a list of line- and column wise divisions of the sheet, and thereafter a crease sequence associated with this division is selected, and eventually, the imposing scheme is determined, on the one hand, based on the selected crease sequence, and, on the other hand, based on the sequences of the pages (7) in the print product.

The invention relates to a method, implemented in a management information system, for automatically computing and determining an imposing scheme, which defines an assignment of a sequence of pages to fields of a sheet, into which the sheet is divided by columns and lines, based on a break sequence, in order to produce the print product, wherein the break sequence defines the sequence of the pages assigned to the fields in the print product.

In order to produce a multipage print product with generally known printing methods, e.g. in offset- letterpress- gravure- flexo- or digital print, several pages are printed together on a large format sheet. For example, a 16 page magazine in DIN-format A4 can be printed on a particular sheet in the standard format 63×88 cm (double sided).

In the present Patent document the flat paper ware in various embodiments, is called a “sheet” in the context of the manufacture of a print product. A “raw sheet” from a paper machine is cut down to a “print sheet” when required, which can be processed by a print machine. The print sheet can be cut into “partial sheets” in the remainder of the process. Print- or partial sheets are folded or “broken” into “folded sheets” in the folding machine, or in a folding system, possibly collated into a “coarse block”, which is e.g. stapled or bound in the “binding” in a combined staple, or in the glue binder, and cut into a block at the other edges.

The known plurality of bound print products is produced through variations of this basic principle. For example, the block for producing a magazine can provided with a cover, made from a heavier paper, which is imprinted in higher quality. For producing a book, several coarse blocks are bound at a common back through string binding.

A folded sheet is folded through cross creasing or parallel folding. In cross creasing, each additional fold of the sheet is performed transversal; in case of parallel creasing it is performed in parallel to the previous fold. In zigzag or fan folding, the creases are performed in parallel and with changing direction, in wrap folding, the fold creases are disposed in parallel and the paper is wound up. A combination of cross crease and parallel fold is called mixed fold. During folding, the direction of the paper and in particular, the weight of the paper, has to be considered. A quadruple crease fold for book binding is generally used up to 80 g, a triple crease fold up to 150 g, a double crease fold up to 170 g, and a single crease fold up to a paper weight of 200 g.

Through folding and creasing, the sheet is divided into fields by lines and by columns. In these fields the particular pages of the print product have to be disposed so that they appear in the print product in the desired sequence (and in the correct orientation). The disposition of the pages on the sheet required for a print product can be changed e.g. through special sheets inserted into the coarse block. Examples for such special sheets are cardboard sheets with postcards, which can be separated, sheets made from transparent paper for multilayer graphics, or sheets with single foiled, lacquered or otherwise specially treated pages. The activity of arranging the sheets is called “imposing”. The arrangement on the sheet is called the “imposing scheme”.

Imposing schemes for print sheets are designed through a generally known, highly specialized computer aided design systems. Compared to the manual designs, such systems offer a plurality of advantages. Through the linking of dimensions, CAD systems, on the one hand, provide an automatic plausibility control, on the other hand, in case of a dimensional change (e.g. change of the side format), linked dimensions, (e.g. the width of the cutoff section, the position or size of a marker) can be automatically adapted. In particular, imposing schemes can be archived with little effort, and are thus available for a subsequent similar application.

Such a highly specialized CAD system, which realizes a method as described above for determining an imposing scheme, is sold e.g. by Creo Inc., Canada, under the trade name “Upfront”. In the known CAD system, imposing schemes are provided as so-called “section plans” in a library. For each imposing scheme, the actual dimensions of the print- or fold sheet, of the particular pages of the print product and of the cutoff sections, and the position and the numbering of the pages on the sheet are defined.

A method as described above is furthermore known from the system with the trade name “Prinect Signa Station”, by Heidelberger Druckmaschinen AG, Germany, for controlling a preprint stage. Also here, a predefined imposing scheme is selected from a library based on entered parameters of the print product and parameters of the execution systems, in particular, of preprint stage-, print-, and folding machines.

For determining an imposing scheme for a special sheet format, which is not defined in the library, for an untypical crease sequence, resulting from a special format, for a print product with a page format, not defined in the library, or even with a non-cataloged page number, according to the known method, in the best case, based on an available scheme, which is as similar as possible, a new imposing scheme has to be determined through manual entry of the parameters. The generation of several different imposing schemes and their comparison under manufacturing, process, or economic considerations, is uneconomical according to the known method.

### Object

Thus it is the object of the invention to simplify the determination of a new imposing scheme.

### Solution

Based on the known methods, it is suggested according to the invention to select, initially based on the one hand on a sheet format of the sheet and on the other hand based on net formats of the pages from a list of line and column wise divisions of the sheet, a possible division of the sheet, and then to select a creasing sequence, associated with this division, and eventually to determine the imposing scheme, based on the one hand on the selected creasing sequence, and on the other hand based on the sequence of the pages in the print product.

The invention is based on the initially trivial finding that various creasing sequences define the same division of a sheet into line- and column wise disposed fields. E.g. the same typical division of the standard format 63×88 cm for sixteen pages DIN A4 (21×29.7 cm) into eight pages in portrait format, disposed in two lines and four columns, is defined through a cross crease and also through mixed folds with a first fold in running direction and subsequent zigzag or winding fold transversal to the running direction.

For each division, the height and the width of the fields are defined with reference to the sheet format to be used. These relative numbers simultaneously define, without considering technically required cutoff sections or over folds, substantially independent of the crease sequence used, maximum values for the page heights and widths, which can be produced. For the print of a sixteen pager with a division of eight pages into two lines and four columns, e.g. the page height is limited by half of the sheet width, and the page width is limited by a quarter of the sheet length.

The question, if a division of a sheet is possible for producing a particular print product, can thus be answered through a simple comparison of two pairs of numbers, thus respectively the heights and widths of the predetermined page- and sheet format. The subsequent selection of the creasing sequence, though restricted through the selection of the division, is not finally determined, however, when there is more than one field. It can consider the possible fold variants, depending on the selected paper format of various available machines and other parameters, e.g. the paper weight.

The crease sequence defines in general form the arrangement of the sequential pages in the print product in the sheet. For a sixteen pager of a book in cross crease, e.g. starting from a first page with the enumeration n on the one side of the sheet in the upper line, the print pages n+4, n+11, n+8, and n+7 can be disposed, in the lower line the pages n+3, n+12, n+15 and n, and on the other side the print pages n+6, n+9, n+10 and n+5, or n+1, n+14, n+13 and n+2 can be disposed. For a third block of a book, starting with the page number 33, on the one side of the sheet, the page numbers 37, 44, 41, and 40 are located accordingly, and 36, 45, 48, and 33, and on the other side, the numbers 39, 42, 43, and 38, and 34, 47, 46, 35. Through the selection of the crease sequence, thus the arrangement of all pages on the sheets is defined, when the start numbering n is given.

According to the method according to the invention, the determination of an imposing scheme is performed in three steps: initially a division, which can be manufactured, is selected solely through a comparison of the net format of the pages with the formats of the fields, which are defined through the known divisions on the available sheet formats. The selection of the fold sequence, based thereupon, is suggested by the manufacturing conditions, if the available machines offer several possibilities. Based on the start page, the imposing scheme is eventually determined exactly from the arrangement of the pages of the print product on the sheet, predetermined through the creasing sequence, the method of binding and the sequence of the bindery processing of the particular folded sheets.

Compared to the manual determination of all parameters, as required by the known method, the determination of the imposing scheme through the method structured according to the invention is thus simplified significantly. This simplified determination of the imposing scheme thus allows in particular its automation.

The method according to the invention can also be applied for a partial sheet from a plurality of partial sheets of a print sheet in an advantageous manner. Thus e.g. the imposing schemes for several coarse blocks of a small format print product can be determined on a large format print sheet, which is initially cut into several fold sheets after printing. Also a different further processing of the partial sheets is conceivable. For example, a partial sheet for producing a stapled in fan fold can be printed in a longitudinal special format, or various partial sheets can be assigned to different print products or additions in different languages of the same print product.

Preferably, the sheet format is selected from a list of sheet formats for performing the method according to the invention. The method according to the invention can then be used universally for the sheet formats provided.

In the context of a method according to the invention, preferably the sheet format and its division are selected, so that in its use the scrap relative to the print sheet format is minimized. Already the comparison of the page- and sheet formats, thus the first step of the automated determination of the imposing scheme, yields the respective scrap for each division and thus allows an early selection according to this criterion. Since the paper cost amounts to approximately 40% of the manufacturing cost of an average print product, the method according to the invention is interesting in particular under economic aspects.

Furthermore, in the context of a method according to the invention, preferably the crease sequence is selected, so that it generates a minimum cost. Special fold sequences like the fan fold, or more rarely used mixed folds can often not be produced in standard machines, but require the use of special machines, which are expensive to buy, set up and maintain, possibly even the letting of subcontracts to an external vendor. When subsequent to the determination of the division of the sheet, the crease sequence is optimized for cost; the method according to the invention allows a particularly economical production of the print product.

Cost factors like the waste percentage and the selection of the crease sequence, but also e.g. specific manufacturing- or storage expenses associated with the particular sheet formats through a delayed delivery of the print product due to the use of a critical path machine can be considered during the selection of the print sheet format, the division, and the crease sequence, in the context of the method according to the invention.

### EMBODIMENT

The method according to the invention is subsequently shown in an exemplary manner based on a fictitious order for the production of a print product and based on the cost accounting for this order in an offset print shop, which is also fictitious. It is shown in:

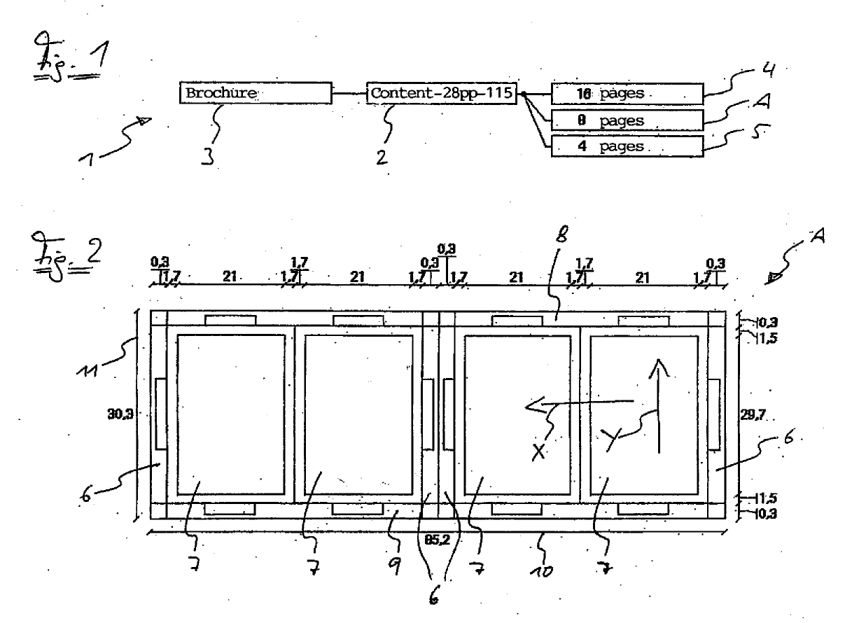

FIG. 1 a tree structure of the print product;

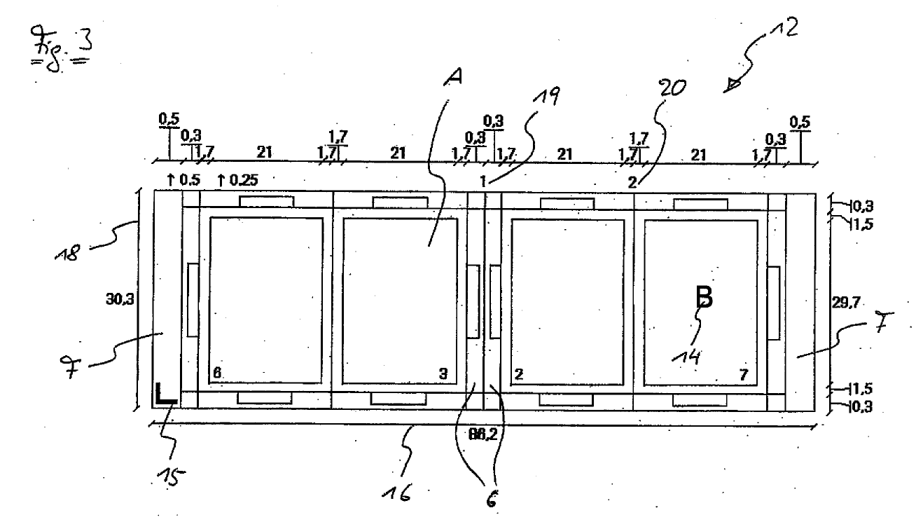

FIG. 2 a division;

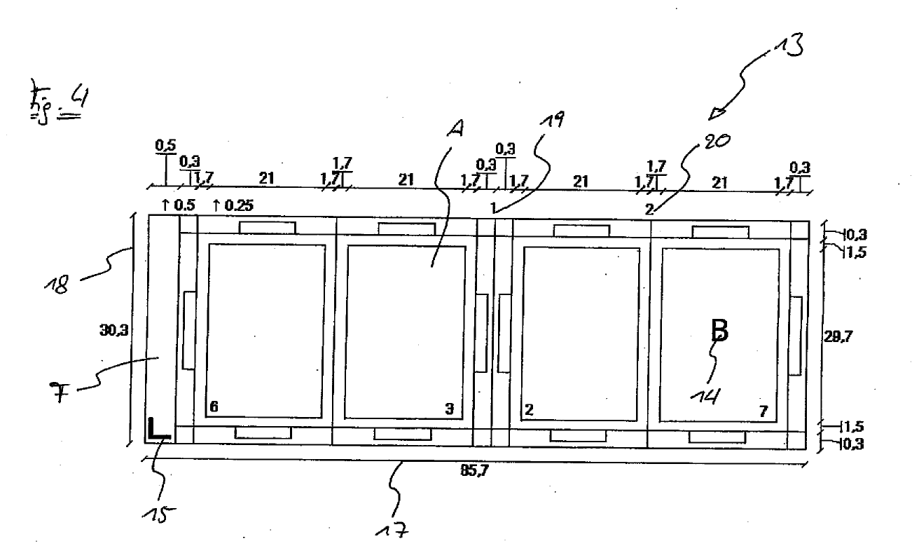

FIG. 3 a first fold sheet;

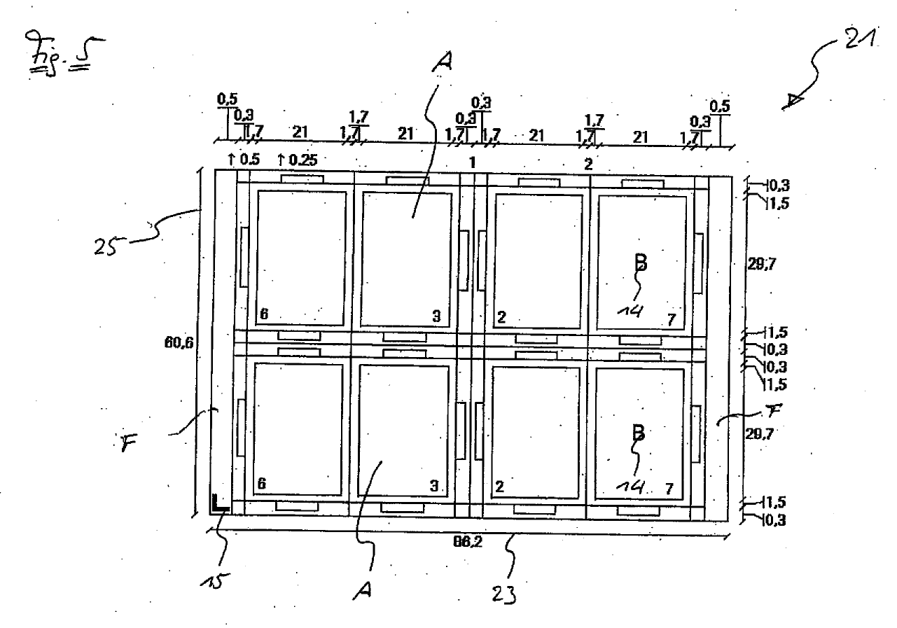

FIG. 4 a second fold sheet;

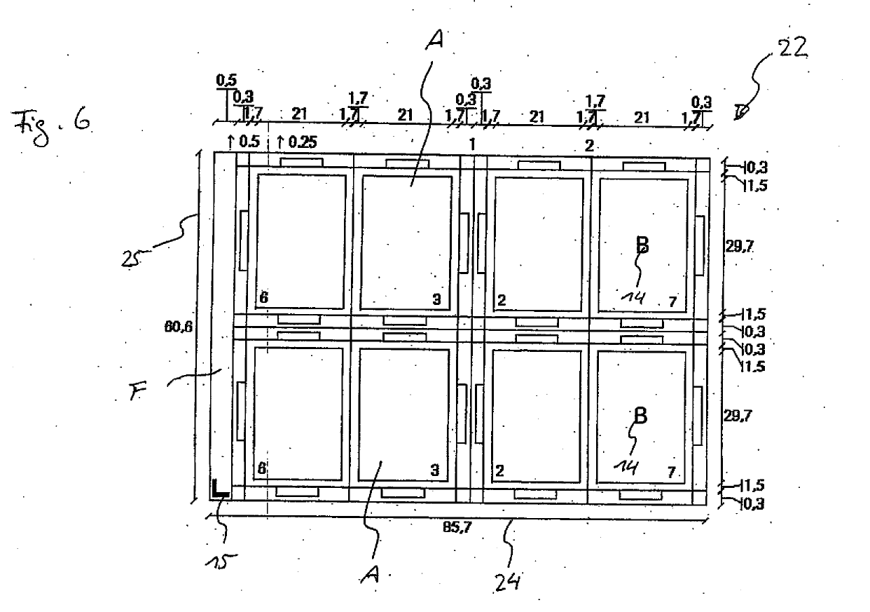

FIG. 5 a third fold sheet; and

FIG. 6 a fourth fold sheet.

In the offset print shop a management information system (MIS) is installed for integrated production planning and control. The MIS has a job costing module besides other modules, which supports the generation of a quote for producing a print product. The job comprises the print production of a wire bound brochure with twenty-eight pages portrait format DIN A4. The brochure is four-colored throughout; the print shall be performed on a paper quality “image print, wood free”, type “sprint image print” with a weight of 115 g/m², the print is not cut.

A configuration file is stored in the MIS, including among others, depending on the bind of the print product, on page format, and orientation, on the parameters of the color print, and of the paper, a list sorted according to manufacturing effort of possible divisions. A unit of pages is designated as a division, which is not cut further in the context of the production of a print product. It is the quasi indivisible “atom” of the print product. A division has at the most the dimensions of the print sheet and maximally comprises the same number of pages as said print sheet. During the manufacture of a stapled print product, as in this case, partial sheets, which are printed previously and possibly cut and folded, are collated with a respective division at the stations of the gang stitch device.

In the configuration file, divisions with 16, 8, 4, and 12 pages are stored for the said parameters (with increasing manufacturing effort). Based on the page number, the MIS selects from them in sequence those divisions with the lowest manufacturing effort and displays the result according to FIG. 1 in a tree structure graphically. The MIS recommends to produce the 28-page (single) product component 2 “content” of the print product 3 “brochure” in a first division 4 with 16, a second division A with 8, and a third division 5 with 4 pages.

Based on the geometric descriptions, stored in the configuration file, of the particular divisions 4, A, 5, the MIS displays them, as reproduced in FIG. 2 in an exemplary manner for the second division A, including the dimensions in a graphic manner, cutoffs are set a width of 0.3 cm as a standard. The second division A (for the 8-pager) initially has a side cut 6 in running direction, followed by 2 pages 7 (in bind), two additional side cutoffs 6, again two pages 7 (in bind), and a final side cutoff 6. In lateral direction Y the second division A has an onset cutoff 8, followed by a page 7 and a final opposite cutoff 9.

The following overview table shows the number of fields for each of the suggested divisions 4, A, 5 in running direction X and in transversal direction Y, the totaled dimensions of the cutoffs and the resulting entire lengths 10, 11:

| Division | Circumference | X × Y | Cutoff X × Y | Format X × Y |
|---|---|---|---|---|
| 4 | 16 pages | 4 × 2 | 1.2 × 1.2 cm | 85.2 × 60.6 cm |
| A | 8 pages | 4 × 1 | 1.2 × 0.6 cm | 85.2 × 30.3 cm |
| 5 | 4 pages | 2 × 1 | 0.6 × 0.6 cm | 42.6 × 30.3 cm |

For each division 4, A, 5, possible folding sheets are designated in the configuration file, sorted according to the manufacturing effort. Based on the geometric descriptions of the folded sheets, also stored in the configuration file, for the selected divisions and the associated crease sequences, the MIS graphically displays the possible fold sheets 12, 13 including dimensions, as shown in the FIGS. 3 and 4 for the 8-pager, in an exemplary manner.

As a reference system of the creasing sequence, it is initially designated on the fold sheets 12, 13 through base side markers 14, which of the pages 7 (the so-called “base page”) remains in place with the same orientation during folding. Through the additional fold location markers 15, the position of the fold sheets 12, 13 is identified in a unique manner, when running through the fold machine.

The following overview table shows the sequence of the geometric elements (over folds F and divisions A) for the possible fold sheets 12, 13 for the 8-pager, in running direction X, and again in running direction X, and in transversal direction Y, the number of the divisions A, the totaled dimensions of the additional cutoffs through the over folds F, and the total lengths 16, 17, 18 resulting there from:

| Fold sheet | Elements | X × Y | Cutoff X × Y | Format X × Y |
|---|---|---|---|---|
| 12 | F-A-F | 1 × 1 | 1.0 × 0.0 cm | 86.2 × 30.3 cm |
| 13 | A-F | 1 × 1 | 0.5 × 0.0 cm | 85.7 × 30.3 cm |

In the context of the crease sequence, furthermore, the sequence of the creases is defined, and in which direction, to the top, or to the bottom, with reference to the base side, they go. The fold sheets 12, 13 according to the FIGS. 3 and 4 are folded respectively initially at the fold mark 19 in running direction X in particular at half of the second fold mark, and then at the second fold mark also in running direction X, approximately at a quarter of the entire length 16, 17 in running direction X, to the top (fold type “F8-2”, according to JDF Specification Release 1.2, CIP4, Zurich/CH 2004, page 368).

Eventually, also the positions of over folds F are defined in the crease sequence, which are set by MIS as a standard with a width of 0.5 cm. Thus the geometry of the fold sheet and the page division directly results from the crease sequence, as well as the page division.

Instead of loading the respective fold sheet 12, 13 with a division A (“single use”) according to the FIGS. 3 and 4, also several divisions A can be disposed on a fold sheet 21, 22 (multiple use) as shown in the FIGS. 5 and 6 in an exemplary manner.

The following overview table shows for these fold sheets 21, 22 with double use for the 8-pager the sequence of the geometric elements (over folds F and divisions A) in running direction X and again in running direction X and in transversal direction Y₁ the number of the divisions A, the totaled dimensions of the additional cutoffs, and the total lengths 23, 24, 25 resulting there from:

| Fold sheet | Elements | X × Y | Cutoff X × Y | Format X × Y |
|---|---|---|---|---|
| 21 | F-A-F | 1 × 2 | 1.0 × 0.0 cm | 86.2 × 60.6 cm |
| 22 | A-F | 1 × 2 | 0.5 × 0.0 cm | 85.7 × 60.6 cm |

Also the fold sheets 21, 22 according to the FIGS. 5 and 6 are creased according to the JDF fold type “F8-2” and subsequently cut in running direction X.

After the selection of the divisions 4, A, 5, and of the imposing schemes, based thereon (shown in an exemplary manner in the geometries of the fold sheets 12, 13, 21, 22) and of the associated crease sequences, all information is available to the MIS for determining the fold sheets and the additional subsequent production steps.

The MIS allows, either based on automatically determined parameters, or in the form of presets, the manual determination of the division and of the crease sequence per fold sheet 21, 22, and of the overall composition of the print sheets. Through the logic linking of the particular steps of the method according to the invention, and their implementation in the MIS, the accordingly changed imposing schemes for producing the print product and there from the respective print sheets with the respective assignment of the pages of the print product can be automatically computed “on the fly”, after each change of a particular parameter.

### DESIGNATIONS

1 tree structure
2 product component
3 print product
4 first division
A second division
5 third division
X running direction
6 side cutoff
7 page (in bind)
Y transversal direction
8 contact cutoff
9 opposite cutoff
10 total length in running direction
11 total length in transversal direction
12 fold sheet
13 fold sheet
14 base side marker
15 fold contact marker
F over fold
16 total length in running direction
17 total length in running direction
18 total length in transversal direction
19 first fold marker
20 second fold marker
21 fold sheet
22 fold sheet
23 total length in running direction
24 total length in running direction
25 total length in running direction

1. A method implemented in a management information system for automatically computing an imposing scheme, defining for the production of a print product (3) an association of a sequence of pages (7) of the print product (3) with fields of a sheet, into which the sheet is divided, based on a crease sequence by lines and columns, wherein the crease sequence defines the sequence of the pages (7) associated with the fields in the print product (3), wherein a possible division of the sheet is initially selected, based on the one hand, on a sheet format of the sheet, and, on the other hand, on net formats of the pages (7) from a list of line- and column wise divisions of the sheet, and thereafter a crease sequence associated with this division is selected, and eventually, the imposing scheme is determined, on the one hand, based on the selected crease sequence, and, on the other hand, based on the sequences of the pages (7) in the print product (3).

2. The method according to claim 1, wherein the sheet is a partial sheet from a plurality of partial sheets of a print sheet.

3. The method according to claim 1 wherein the sheet format is selected from a list of sheet formats.

4. The method according to claim 3, wherein sheet format is selected, during whose use the waste, relative to the format of the print sheet, is minimized.

5. The method according to claim 1, wherein the division of the sheet is selected, so that through its use the waste relative to the sheet format is minimized.

6. The method according to claim 5, wherein the crease sequence is selected so that it generates minimum cost.
